(19) United States
(12) Patent Application Publication
(10) Pub. No.: US 2026/0319509 A1
(43) Pub. Date: Oct. 15, 2026

(54) ROBOT ESCAPE METHOD AND APPARATUS, PROCESSOR AND ROBOT

(71) Applicants: GREE ELECTRIC APPLIANCES, INC. OF ZHUHAI, Zhuhai, Guangdong (CN); LEAYUN TECHNOLOGY CO., LTD. OF ZHUHAI, Zhuhai, Guangdong (CN)

(72) Inventors: Shaobin LI, Zhuhai, Guangdong (CN); Gao CHEN, Zhuhai, Guangdong (CN); Miaoquan LIU, Zhuhai, Guangdong (CN); Zefeng LI, Zhuhai, Guangdong (CN); Yanyu CHEN, Zhuhai, Guangdong (CN); Yaqi MA, Zhuhai, Guangdong (CN)

(21) Appl. No.: 19/104,266

(22) PCT Filed: Apr. 27, 2023
(86) PCT No.: PCT/CN2023/091235

§ 371 Date: Feb. 17, 2025

(30) Foreign Application Priority Data
Aug. 17, 2022 (CN) 202210988109.5

(51) Int. Cl. G05D 1/639; A47L 11/24; A47L 11/40; G05D 105/10

(52) U.S. Cl. CPC G05D 1/639; A47L 11/24; A47L 11/4011; A47L 11/4061; A47L 2201/04; G05D 2105/10

(57) ABSTRACT

Disclosed herein are a robot escape method and apparatus, a processor, and a robot. The method includes: acquiring a historical running trajectory of a robot; according to the historical running trajectory of the robot, obtaining a driving-in position and a driving-in angle of the robot entering a narrow region through a preset narrow passage; according to the driving-in position and the driving-in angle, determining a driving-out position and a driving-out angle of the robot driving out of the narrow region through the preset narrow passage; and controlling the robot to drive out of the narrow region based on the driving-out position and the driving-out angle.

### CROSS-REFERENCE TO RELATED APPLICATION

This application is a U.S. National Phase Application of International Patent Application No. PCT/CN2023/091235, filed Apr. 27, 2023, which claims the priority of Chinese Patent Disclosure 202210988109.5, filed on Aug. 17, 2022, and entitled “Robot Escape Method and Apparatus, Processor and Robot”, the entire contents of which are herein incorporated by reference.

### TECHNICAL FIELD

The present disclosure relates to the field of robots, and in particular to, a robot escape method and apparatus, a processor, and a robot.

### BACKGROUND

With the acceleration in the pace of life, in order to save household cleaning times, sweeping robots have entered thousands of households and become powerful assistants for household cleaning. The sweeping robots utilize sensing devices installed thereon to sense environments where they are located, and plan appropriate cleaning strategies, so as to clean household grounds.

In real home environments, there are a large number of complex regions and corners, such as various tables and chairs, and placed bracket furniture. A conventional sweeping robot judges whether it may enter the bottom of a chair or a bracket region by collision, and especially when the distance between the legs of the chair or the distance between horizontal planes of the bracket is close to the width or diameter of the sweeping robot, the sweeping robot enters the bottom of the chair or the bracket but cannot come out. If the sweeping robot is stuck in these regions and cannot autonomously find a strategy to escape, the sweeping robot terminates the cleaning, and then may only give an alarm and wait for human help, thereby resulting in very poor cleaning efficiency and user experience.

Therefore, the existing robots (including the sweeping robots) have the problem of being unable to escape from narrow regions.

### SUMMARY

The main objective of the present disclosure is to provide a robot escape method and apparatus, a processor, and a robot.

In order to achieve the above objective, according to one aspect of the present disclosure, a robot escape method is provided, including: acquiring a historical running trajectory of a robot; according to the historical running trajectory of the robot, obtaining a driving-in position and a driving-in angle of the robot entering a narrow region through a preset narrow passage; according to the driving-in position and the driving-in angle, determining a driving-out position and a driving-out angle of the robot driving out of the narrow region through the preset narrow passage; and controlling the robot to drive out of the narrow region based on the driving-out position and the driving-out angle.

In some embodiments, the narrow region is formed by a plurality of obstacle points in a surrounding manner, and a narrow passage is formed between two adjacent obstacle points among the plurality of obstacle points, the preset narrow passage is one of the narrow passages. The driving-in position is an intersection position between a connecting line of the two obstacle points in the preset narrow passage and the historical running trajectory, the driving-in angle is an included angle between an entry direction of the robot and a vertical line, and the vertical line is a straight line perpendicular to the connecting line of the two obstacle points in the preset narrow passage. The driving-out position is an intersection position between a trajectory of the robot driving out of the narrow region and the connecting line of the two obstacle points in the preset narrow passage, and the driving-out angle is an included angle between a driving-out direction of the robot and the vertical line.

In some embodiments, according to the driving-in position and the driving-in angle, determining the driving-out position and the driving-out angle of the robot driving out of the narrow region through the preset narrow passage includes: determining a driving-out reference position and a driving-out reference angle; determining an optimal driving-out position in the neighborhood of the driving-out reference position, and determining an optimal driving-out angle in the neighborhood of the driving-out reference angle; and determining the optimal driving-out position as the driving-out position of the robot driving out of the narrow region through the preset narrow passage, and determining the optimal driving-out angle as the driving-out angle of the robot driving out of the narrow region through the preset narrow passage.

In some embodiments, determining the driving-out reference position and the driving-out reference angle includes: determining that the driving-out reference angle is equal to the driving-in angle; and determining the driving-out reference position according to a distance information, wherein the distance information includes a first distance and a second distance, the first distance is a distance between the driving-in position and a first obstacle point, the second distance is a distance between the driving-out reference position and a second obstacle point, the first obstacle point is an obstacle point corresponding to a smaller distance in distances between the driving-in position and the two obstacle points in the preset narrow passage, the second obstacle point is an obstacle point corresponding to a greater distance in the distances between the driving-in position and the two obstacle points in the preset narrow passage, and the driving-out reference position is selected as a position when the second distance is equal to the first distance.

In some embodiments, determining the optimal driving-out position in the neighborhood of the driving-out reference position, and determining the optimal driving-out angle in the neighborhood of the driving-out reference angle includes: in a case that the robot successfully drives out of the narrow region based on the driving-out reference position and the driving-out reference angle, determining that the driving-out reference position is the optimal driving-out position, and determining that the driving-out reference angle is the optimal driving-out angle; in a case that the robot does not successfully drive out of the narrow region based on the driving-out reference position and the driving-out reference angle, executing a predetermined step at least once, until the robot successfully drives out of the narrow region, wherein the predetermined step includes: selecting a position in the neighborhood of the driving-out reference position as a current driving-out position, and selecting an angle in the neighborhood of the driving-out reference angle as a current driving-out angle; and taking a driving-out position selected when the predetermined step is executed for a last time as the optimal driving-out position, and taking a driving-out angle selected when the predetermined step is executed for the last time as the optimal driving-out angle.

In some embodiments, according to the driving-in position and the driving-in angle, determining the driving-out position and the driving-out angle of the robot driving out of the narrow region through the preset narrow passage includes: acquiring a trapped duration of the robot; and in a case that the trapped duration is greater than a predetermined duration, according to the driving-in position and the driving-in angle, determining the driving-out position and the driving-out angle of the robot driving out of the narrow region through the preset narrow passage.

In some embodiments, according to the historical running trajectory of the robot, obtaining the driving-in angle of the robot entering the narrow region through the preset narrow passage includes: selecting a first point and a second point in the neighborhood of the driving-in position on the historical running trajectory; acquiring a first slope of a connecting line of the first point and the second point; acquiring a second slope of the connecting line of the two obstacle points in the preset narrow passage; determining a third slope of the vertical line according to the second slope; and determining the driving-in angle according to the first slope and the third slope.

In some embodiments, the first point and the second point are located on a same side of the historical running trajectory, or the first point and the second point are located on two sides of the historical running trajectory.

According to another aspect of the present disclosure, a robot escape apparatus is provided, including: a first acquisition unit, configured to acquire a historical running trajectory of a robot; a second acquisition unit, configured to: according to the historical running trajectory of the robot, obtain a driving-in position and a driving-in angle of the robot entering a narrow region through a preset narrow passage; a determination unit, configured to: according to the driving-in position and the driving-in angle, determine a driving-out position and a driving-out angle of the robot driving out of the narrow region through the preset narrow passage; and a control unit, configured to: control the robot to drive out of the narrow region based on the driving-out position and the driving-out angle.

In some embodiments, the narrow region is formed by a plurality of obstacle points in a surrounding manner, and a narrow passage is formed between two adjacent obstacle points among the plurality of obstacle points;, the preset narrow passage is one of the narrow passages; the driving-in position is an intersection position between a connecting line of the two obstacle points in the preset narrow passage and the historical running trajectory, the driving-in angle is an included angle between an entry direction of the robot and a vertical line, and the vertical line is a straight line perpendicular to the connecting line of the two obstacle points in the preset narrow passage; and the driving-out position is an intersection position between a trajectory of the robot driving out of the narrow region and the connecting line of the two obstacle points in the preset narrow passage, and the driving-out angle is an included angle between a driving-out direction of the robot and the vertical line.

According to another aspect of the present disclosure, a processor is provided, wherein the processor executes the steps of the method in any of the above embodiments when running.

According to another aspect of the present disclosure, a robot is provided, including: one or more processors, a memory, and one or more programs, wherein the one or more programs are stored in the memory, and when the one or more programs are executed by the one or more processors, the one or more processors are caused to execute the steps of the method in any of the above embodiments.

In some embodiments, the robot is a sweeping robot.

### BRIEF DESCRIPTION OF THE DRAWINGS

The drawings, which constitute a part of the present disclosure, are used to provide a further understanding of the present disclosure, and schematic embodiments of the present disclosure and descriptions thereof are used to explain the present disclosure, and do not constitute an improper limitation on the present disclosure. In the drawings:

FIG. 1 illustrates a flowchart of a robot escape method according to an embodiment of the present disclosure;

FIG. 2 illustrates a schematic diagram of a robot driving out of a narrow region according to an embodiment of the present disclosure; and

FIG. 3 is a schematic diagram of a robot escape apparatus according to an embodiment of the present disclosure.

### DETAILED DESCRIPTION OF THE EMBODIMENTS

It should be noted that, in the case of no conflict, embodiments in the present disclosure and features in the embodiments may be combined with each other. The present disclosure will be described in detail below with reference to the drawings and in combination with the embodiments.

In order to enable those skilled in the art to better understand the solutions of the present disclosure, a clear and complete description of technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, fall into the protection scope of the present disclosure.

It should be noted that, the terms “first” and “second” and the like in the specification, the claims and the drawings of the present disclosure are used for distinguishing similar objects, and are not necessarily used for describing a specific sequence or precedence order. It should be understood that the data used in this way may be interchanged under appropriate circumstances to describe the embodiments of the present disclosure herein. Furthermore, the terms “including” and “having”, and any variations thereof are intended to cover non-exclusive inclusions, for example, processes, methods, systems, products or devices including a series of steps or units are not necessarily limited to those clearly listed steps or units, but may include other steps or units that are not clearly listed or are inherent to these processes, methods, products or devices.

It should be understood that when one element (e.g, a layer, a film, a region, or a substrate) is described as being “on” another element, the element may be directly on the other element, or there may be an intermediate element. Moreover, in the specification and the claims, when one element is described as being “connected” to another element, the element may be “directly connected” to the other element, or “connected” to the other element by a third element.

As introduced in the background art, a robot in the prior art cannot escape from a narrow region, therefore in order to solve the problem of the robot being enable to escape from the narrow region, embodiments of the present disclosure provide a robot escape method and apparatus, a processor, and a robot.

According to an embodiment of the present disclosure, a robot escape method is provided.

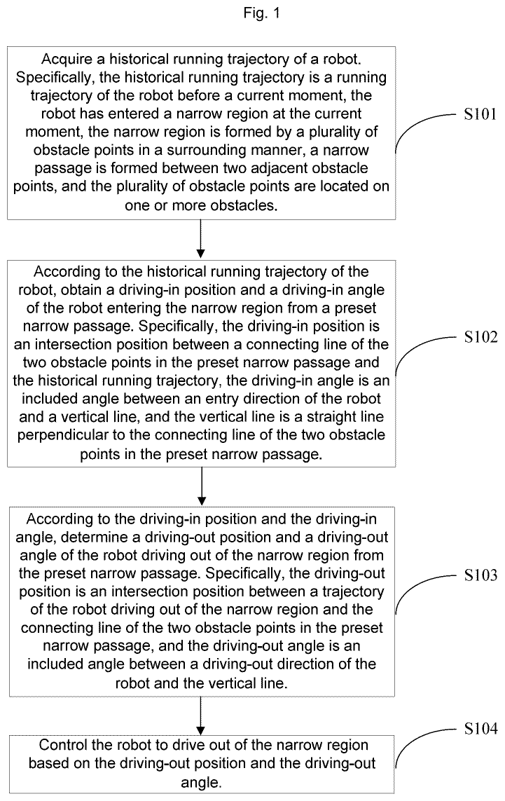

FIG. 1 illustrates a flowchart of a robot escape method according to an embodiment of the present disclosure, and as shown in FIG. 1, the method includes the following steps S101 to S104.

Step S101, acquiring a historical running trajectory of a robot. Specifically, the historical running trajectory is a running trajectory of the robot before a current moment, the robot is located in a narrow region at the current moment, the narrow region is formed by a plurality of obstacle points in a surrounding manner, a narrow passage is formed between two adjacent obstacle points, and the plurality of obstacle points are located on one or more obstacles.

Step S102, according to the historical running trajectory of the robot, obtaining a driving-in position and a driving-in angle of the robot entering the narrow region through a preset narrow passage. Specifically, the driving-in position is an intersection position between a connecting line of the two obstacle points in the preset narrow passage and the historical running trajectory, the driving-in angle is an included angle between an entry direction of the robot and a vertical line, and the vertical line is a straight line perpendicular to the connecting line of the two obstacle points in the preset narrow passage.

Step S103, according to the driving-in position and the driving-in angle, determining a driving-out position and a driving-out angle of the robot driving out of the narrow region through the preset narrow passage. Specifically, the driving-out position is an intersection position between a trajectory of the robot driving out of the narrow region and the connecting line of the two obstacle points in the preset narrow passage, and the driving-out angle is an included angle between a driving-out direction of the robot and the vertical line.

Step S104, controlling the robot to drive out of the narrow region based on the driving-out position and the driving-out angle.

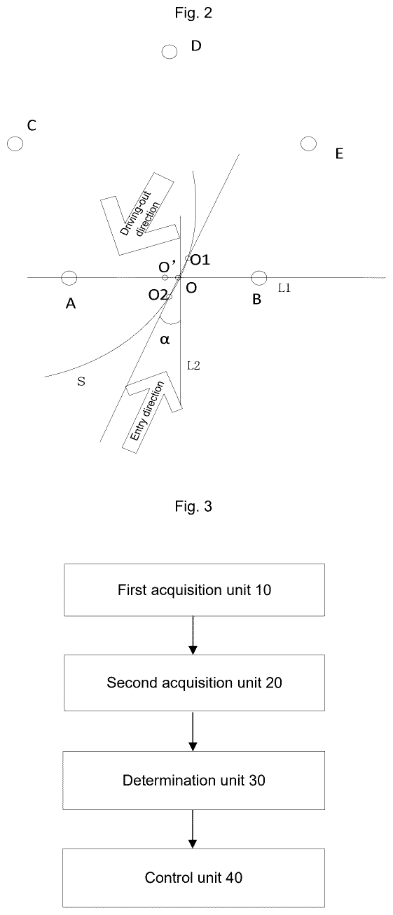

FIG. 2 illustrates a schematic diagram of the robot driving out of the narrow region according to an embodiment of the present disclosure, as shown in FIG. 2, a connecting line of an obstacle point A and an obstacle point B is L1, the vertical line is L2, the historical running trajectory is S, an intersection of the historical running trajectory with the connecting line L1 of the obstacle point A and the obstacle point B is O, the driving-in angle is a, and the driving-out position is O′.

Specifically, the narrow region is, for example, a region enclosed by the bottom of a chair, a region enclosed by the bottom of a bracket, and the narrow passage is, for example, a passage between two legs of the chair.

Specifically, the robot is a sweeping robot.

In the embodiment of the present disclosure, the historical running trajectory of the robot is acquired, the driving-in position and the driving-in angle of the robot entering the narrow region through the preset narrow passage are obtained according to the acquired historical running trajectory of the robot, then the driving-out position and the driving-out angle of the robot driving out of the narrow region through the preset narrow passage are determined according to the driving-in position and the driving-in angle, and finally the robot is controlled to drive out of the narrow region based on the driving-out position and the driving-out angle. In the present solution, the driving-out position and the driving-out angle are determined according to the driving-in position and the driving-in angle, so that the robot smoothly drives out of the narrow region, thereby solving the problem of the robot being unable to escape from the narrow region, and improving the user experience.

It should be noted that the steps shown in the flowchart of the drawings may be executed in a computer system such as a group of computer-executable instructions, although a logical sequence is shown in the flowchart, in some cases, the steps shown or described may be executed in a sequence different from that described herein.

In one embodiment of the present disclosure, the step S103: according to the driving-in position and the driving-in angle, determining the driving-out position and the driving-out angle of the robot driving out of the narrow region through the preset narrow passage, includes: determining a driving-out reference position and a driving-out reference angle; determining an optimal driving-out position in the neighborhood of the driving-out reference position, and determining an optimal driving-out angle in the neighborhood of the driving-out reference angle; and determining the optimal driving-out position as the driving-out position of the robot driving out of the narrow region through the preset narrow passage, and determining the optimal driving-out angle as the driving-out angle of the robot driving out of the narrow region through the preset narrow passage.

In one embodiment of the present disclosure, determining the driving-out reference position and the driving-out reference angle includes: determining the driving-out reference position according to a distance information, and determining that the driving-out reference angle is equal to the driving-in angle. Specifically, the distance information includes a first distance and a second distance, the first distance is a distance between the driving-in position and a first obstacle point, and the second distance is a distance between the driving-out reference position and a second obstacle point, wherein the first obstacle point is an obstacle point corresponding to a smaller distance in distances between the driving-in position and the two obstacle points in the preset narrow passage, the second obstacle point is an obstacle point corresponding to a greater distance in the distances between the driving-in position and the two obstacle points in the preset narrow passage, and the driving-out reference position is selected as a position when the second distance is equal to the first distance. That is, the driving-out reference position and the driving-out reference angle are respectively determined according to the distance information and the driving-in angle, then the optimal driving-out position is determined in the neighborhood of the driving-out reference position, the optimal driving-out angle is determined in the neighborhood of the driving-out reference angle, and finally the robot is controlled to drive out of the narrow region based on the optimal driving-out position and the optimal driving-out angle.

In one embodiment of the present disclosure, determining the optimal driving-out position in the neighborhood of the driving-out reference position, and determining the optimal driving-out angle in the neighborhood of the driving-out reference angle includes: in a case that the robot successfully drives out of the narrow region based on the driving-out reference position and the driving-out reference angle, determining that the driving-out reference position is the optimal driving-out position, and determining that the driving-out reference angle is the optimal driving-out angle; and in a case that the robot does not successfully drive out of the narrow region based on the driving-out reference position and the driving-out reference angle, executing a predetermined step at least once until the robot successfully drives out of the narrow region. The predetermined step includes: selecting a position in the neighborhood of the driving-out reference position as a current driving-out position, and selecting an angle in the neighborhood of the driving-out reference angle as a current driving-out angle. By executing the predetermined step at least once, the robot drives out of the narrow region. A driving-out position selected when the predetermined step is executed for a last time is taken as the optimal driving-out position, and a driving-out angle selected when the predetermined step is executed for the last time is taken as the optimal driving-out angle. That is, in a case that the robot does not successfully drive out of the narrow region based on the driving-out reference position and the driving-out reference angle, the predetermined step is continuously iterated until the robot successfully drives out of the narrow region, and finally the optimal driving-out position and the optimal driving-out angle are determined.

In one embodiment of the present disclosure, the first distance is a distance between the driving-in position and the first obstacle point, the second distance is a distance between the driving-out reference position and a second obstacle point, wherein the first obstacle point is an obstacle point corresponding to a smaller distance in distances between the driving-in position and the two obstacle points in the preset narrow passage, the second obstacle point is an obstacle point corresponding to a greater distance in the distances between the driving-in position and two obstacle points in the preset narrow passage, and the driving-out reference position is selected as a position when the second distance is equal to the first distance. In this way, it is easy to escape.

In one embodiment of the present disclosure, the step S103: according to the driving-in position and the driving-in angle, determining the driving-out position and the driving-out angle of the robot driving out of the narrow region through the preset narrow passage, includes: acquiring a trapped duration of the robot; and in a case that the trapped duration is greater than a predetermined duration, according to the driving-in position and the driving-in angle, determining the driving-out position and the driving-out angle of the robot driving out of the narrow region through the preset narrow passage. That is, in a case that it is determined according to the trapped duration that the robot is really trapped in the narrow region, the step S103 is executed.

In one embodiment of the present disclosure, the step S102: according to the historical running trajectory of the robot, obtaining the driving-in angle of the robot entering the narrow region through the preset narrow passage, includes: selecting a first point and a second point in the neighborhood of the driving-in position on the historical running trajectory; acquiring a first slope of a connecting line of the first point and the second point; acquiring a second slope of the connecting line of the two obstacle points in the preset narrow passage; determining a third slope of the vertical line according to the second slope; and determining the driving-in angle according to the first slope and the third slope. As shown in FIG. 2, according to the driving-in position O determined in the step S221, two points near O are selected according to an approximate slope method, for example, coordinates O₂(O₂ₓ, O_{2y}) at a previous second of the intersection O are generated, coordinates O₁(O₁ₓ, O_{1y}) at a subsequent second of the intersection are generated, at this time, the slope of a straight line O₁O₂ is calculated according to a slope calculation formula as:

$${K}_{{O}_{1} {O}_{2}} = \frac{( {O}_{2 y} - {O}_{1 y} )}{( {O}_{2 x} - {O}_{1 x} )} ;$$

and similarly, according to the coordinates of the two obstacle points A and B, the slope K_{AB} of the straight line AB is calculated, at this time, the slope of the vertical line of the straight line AB is

$$- \frac{1}{{K}_{A B}} ,$$

then an included angle between the straight line O₁O₂ and the vertical line of the straight line AB is:

$$tan α = \frac{( {k}_{{O}_{1} {O}_{2}} + \frac{1}{{k}_{AB}} )}{( 1 - \frac{{k}_{{O}_{1} {O}_{2}}}{{k}_{AB}} )} .$$

In one embodiment of the present disclosure, the first point O₁ and the second point O₂ are located on a same side of the historical running trajectory, or the first point O₁ and the second point O₂ are located on two sides of the historical running trajectory.

An embodiment of the present disclosure further provides a robot escape apparatus, and it should be noted that the robot escape apparatus in the embodiment of the present disclosure may be used for executing the robot escape method provided in the embodiment of the present disclosure. The robot escape apparatus provided in the embodiment of the present disclosure will be introduced below.

FIG. 3 is a schematic diagram of a robot escape apparatus according to an embodiment of the present disclosure. As shown in FIG. 3, the apparatus includes a first acquisition unit 10, a second acquisition unit 20, a determination unit 30, and a control unit 40.

The first acquisition unit 10 is configured to acquire a historical running trajectory of a robot. Specifically, the historical running trajectory is a running trajectory of the robot before a current moment, the robot is located in a narrow region at the current moment, the narrow region is formed by a plurality of obstacle points in a surrounding manner, a narrow passage is formed between two adjacent obstacle points, and the plurality of obstacle points are located on one or more obstacles.

The second acquisition unit 20 is configured to: according to the historical running trajectory of the robot, obtain a driving-in position and a driving-in angle of the robot entering a narrow region through a preset narrow passage. Specifically, the driving-in position is an intersection position between a connecting line of the two obstacle points in the preset narrow passage and the historical running trajectory, the driving-in angle is an included angle between an entry direction of the robot and a vertical line, and the vertical line is a straight line perpendicular to the connecting line of the two obstacle points in the preset narrow passage.

The determination unit 30 is configured to: according to the driving-in position and the driving-in angle, determine a driving-out position and a driving-out angle of the robot driving out of the narrow region through the preset narrow passage. Specifically, the driving-out position is an intersection position between a trajectory of the robot driving out of the narrow region and the connecting line of the two obstacle points in the preset narrow passage, and the driving-out angle is an included angle between a driving-out direction of the robot and the vertical line.

The control unit 40 is configured to control the robot to drive out of the narrow region based on the driving-out position and the driving-out angle.

Specifically, the narrow region is, for example, a region enclosed by the bottom of a chair, a region enclosed by the bottom of a bracket, and the narrow passage is, for example, a passage between two legs of the chair.

Specifically, the robot is a sweeping robot.

In the embodiment of the present disclosure, the first acquisition unit acquires the historical running trajectory of the robot, the second acquisition unit obtains the driving-in position and the driving-in angle of the robot entering the narrow region through the preset narrow passage according to the historical running trajectory of the robot, the determination unit determines the driving-out position and the driving-out angle of the robot driving out of the narrow region through the preset narrow passage according to the driving-in position and the driving-in angle, and the control unit controls the robot to drive out of the narrow region based on the driving-out position and the driving-out angle. In the present solution, the driving-out position and the driving-out angle are determined according to the driving-in position and the driving-in angle, so that the robot smoothly drives out of the narrow region, thereby solving the problem of the robot being unable to escape from the narrow region, and improving the user experience.

In one embodiment of the present disclosure, the determination unit includes a first determination module and a second determination module. The first determination module is configured to determine a driving-out reference position and a driving-out reference angle. The second determination module is configured to determine an optimal driving-out position in the neighborhood of the driving-out reference position, determine an optimal driving-out angle in the neighborhood of the driving-out reference angle, determine the optimal driving-out position as the driving-out position of the robot driving out of the narrow region through the preset narrow passage, and determine the optimal driving-out angle as the driving-out angle of the robot driving out of the narrow region through the preset narrow passage.

In one embodiment of the present disclosure, the first determination module is specifically configured to determine the driving-out reference position and the driving-out reference angle as follows: the first determination module is configured to determine the driving-out reference position according to a distance information, and determine that the driving-out reference angle is equal to the driving-in angle. Specifically, the distance information includes a first distance and a second distance, the first distance is a distance between the driving-in position and a first obstacle point, and the second distance is a distance between the driving-out reference position and a second obstacle point, wherein the first obstacle point is an obstacle point corresponding to a smaller distance in distances between the driving-in position and the two obstacle points in the preset narrow passage, the second obstacle point is an obstacle point corresponding to a greater distance in the distances between the driving-in position and the two obstacle points in the preset narrow passage, and the driving-out reference position is selected as a position when the second distance is equal to the first distance. That is, the driving-out reference position and the driving-out reference angle are respectively determined according to the distance information and the driving-in angle, then the optimal driving-out position is determined in the neighborhood of the driving-out reference position, the optimal driving-out angle is determined in the neighborhood of the driving-out reference angle, and finally the robot is controlled to drive out of the narrow region based on the optimal driving-out position and the optimal driving-out angle.

In one embodiment of the present disclosure, the second determination module includes a determination sub-module, an execution sub-module, and a processing sub-module.

The determination sub-module is configured to: in a case that the robot successfully drives out of the narrow region based on the driving-out reference position and the driving-out reference angle, determine that the driving-out reference position is the optimal driving-out position, and determine that the driving-out reference angle is the optimal driving-out angle.

The execution sub-module is configured to: in a case that the robot does not successfully drive out of the narrow region based on the driving-out reference position and the driving-out reference angle, execute a predetermined step at least once until the robot successfully drives out of the narrow region, so that the robot drives out of the narrow region, wherein the predetermined step includes: selecting a position in the neighborhood of the driving-out reference position as a current driving-out position, and selecting an angle in the neighborhood of the driving-out reference angle as a current driving-out angle.

The processing sub-module is configured to take a driving-out position selected when the predetermined step is executed for a last time as the optimal driving-out position, and take a driving-out angle selected when the predetermined step is executed for the last time as the optimal driving-out angle. That is, in a case that the robot does not successfully drive out of the narrow region based on the driving-out reference position and the driving-out reference angle, the predetermined step is continuously iterated until the robot successfully drives out of the narrow region, and finally the optimal driving-out position and the optimal driving-out angle are determined.

In one embodiment of the present disclosure, the first distance is a distance between the driving-in position and a first obstacle point, the second distance is a distance between the driving-out reference position and a second obstacle point, wherein the first obstacle point is an obstacle point corresponding to a smaller distance in distances between the driving-in position and the two obstacle points in the preset narrow passage, the second obstacle point is an obstacle point corresponding to a greater distance in the distances between the driving-in position and two obstacle points in the preset narrow passage, and the driving-out reference position is selected as a position when the second distance is equal to the first distance. In this way, it is easier to escape.

In one embodiment of the present disclosure, the determination unit includes a first acquisition module and a third determination module, wherein the first acquisition module is configured to acquire a trapped duration of the robot. The third determination module is configured to: in a case that the trapped duration is greater than a predetermined duration, according to the driving-in position and the driving-in angle, determine the driving-out position and the driving-out angle of the robot driving out of the narrow region through the preset narrow passage. That is, in a case that it is determined according to the trapped duration that the robot is really trapped in the narrow region, the determination unit determines the driving-out position and the driving-out angle of the robot driving out of the narrow region through the preset narrow passage according to the driving-in position and the driving-in angle.

In one embodiment of the present disclosure, the second acquisition unit includes a selection module, a second acquisition module, a third acquisition module, a fourth determination module, and a fifth determination module. The selection module is configured to select a first point and a second point in the neighborhood of the driving-in position on the historical running trajectory. The second acquisition module is configured to acquire a first slope of a connecting line of the first point and the second point. The third acquisition module is configured to acquire a second slope of the connecting line of the two obstacle points in the preset narrow passage. The fourth determination module is configured to determine a third slope of the vertical line according to the second slope. The fifth determination module is configured to determine the driving-in angle according to the first slope and the third slope. As shown in FIG. 2, according to the driving-in position O determined in the step S221, two points near O are selected according to an approximate slope method, for example, coordinates O₂(O₂ₓ, O_{2y}) at a previous second of the intersection O are generated, coordinates O₁(O₁ₓ, O_{1y}) at a subsequent second of the intersection are generated, at this time, the slope of a straight line O₁O₂ is calculated according to a slope calculation formula as:

$${K}_{{O}_{1} {O}_{2}} = \frac{( {O}_{2 y} - {O}_{1 y} )}{( {O}_{2 x} - {O}_{1 x} )} ;$$

and similarly, according to the coordinates of the two obstacle points A and B, the slope K_{AB} of the straight line AB is calculated, at this time, the slope of the vertical line of the straight line AB is

$$- \frac{1}{{K}_{A B}} ,$$

then an included angle between the straight line O₁O₂ and the vertical line of the straight line AB is:

$$tan α = \frac{( {k}_{{O}_{1} {O}_{2}} + \frac{1}{{k}_{AB}} )}{( 1 - \frac{{k}_{{O}_{1} {O}_{2}}}{{k}_{AB}} )} .$$

In one embodiment of the present disclosure, the first point O₁ and the second point O₂ are located on a same side of the historical running trajectory, or the first point O₁ and the second point O₂ are located on two sides of the historical running trajectory.

In one specific embodiment of the present disclosure, the robot is a sweeping robot.

The robot escape apparatus includes a processor and a memory, wherein the first acquisition unit, the second acquisition unit, the determination unit, the control unit, and the like may all be stored in the memory as program units, and the processor executes the program units stored in the memory to implement corresponding functions.

The processor includes a kernel, and the kernel calls a corresponding program unit from the memory. One or more kernels may be provided, and the robot is caused to smoothly drive out of the narrow region by adjusting the parameters of the kernel.

The memory may include a volatile memory, a random access memory (RAM) and/or a non-volatile memory and other forms in a computer-readable medium, such as a read-only memory (ROM) or a flash random access memory (flash RAM), and the memory includes at least one storage chip.

An embodiment of the present invention provides a computer-readable storage medium, wherein the computer-readable storage medium includes a stored program, and when the program runs, a device where the computer-readable storage medium is located is controlled to execute the robot escape method.

An embodiment of the present invention provides a processor, wherein the processor is configured to run a program, and the program executes the robot escape method according to any of the above embodiments when running.

An embodiment of the present invention provides a processor, wherein the processor executes the robot escape method according to any of the above embodiments when running.

An embodiment of the present invention provides a robot, including: one or more processors, a memory, and one or more programs, wherein the one or more programs are stored in the memory, and when the one or more programs are executed by the one or more processors, the one or more processors are caused to execute the steps of the robot escape method according to any of the above embodiments.

An embodiment of the present invention provides a device, including a processor, a memory, and a program stored in the memory and executable on the processor, wherein the processor, when executing the processor, implements the steps of the robot escape method according to any of the above embodiments.

The device herein may be a server, a PC, a PAD, a mobile phone, or the like.

The present disclosure further provides a computer program product, which, when executed on a data processing device, is applicable to executing the steps of the robot escape method according to any of the above embodiments.

Those skilled in the art should understand that, the embodiments of the present disclosure may be provided as a method, a system or a computer program product. Accordingly, the present disclosure may adopt the form of a complete hardware embodiment, a complete software embodiment, or an embodiment combining software with hardware. Moreover, the present disclosure may adopt the form of a computer program product which is implemented on one or more computer-usable storage media (including, but not limited to, a magnetic disk memory, a CD-ROM and an optical memory and the like) including computer-usable program codes.

The present disclosure is described in accordance with a flowchart and/or a block diagram of the method, the device (system) and the computer program product in the embodiments of the present disclosure. It should be understood that, computer program instructions may implement each flow and/or block in the flowchart and/or the block diagram and combinations of the flows and/or blocks in the flowchart and/or the block diagram. These computer program instructions may be provided for a general-purpose computer, a special-purpose computer, an embedded processor or processors of other programmable data processing devices to generate a machine, so that the instructions executed by the computers or the processors of the other programmable data processing devices generate an apparatus for implementing specified functions in one or more flows of the flowchart and/or one or more blocks of the block diagram.

These computer program instructions may also be stored in a computer-readable memory that is capable of guiding the computers or the other programmable data processing devices to work in particular manners, so that the instructions stored in the computer-readable memory generate a product including an instruction apparatus, and the instruction apparatus implements the specified functions in one or more flows of the flow diagram and/or one or more blocks of the block diagram.

These computer program instructions may also be loaded onto the computers or the other programmable data processing devices, so as to execute a series of operation steps on the computers or the other programmable data processing devices to produce processing that is implemented by the computers, so that the instructions executed on the computers or the other programmable data processing devices provide steps for implementing the specified functions in one or more flows of the flow diagram and/or one or more blocks of the block diagram.

In a typical configuration, a computing device includes one or more central processing units (CPUs), an input/output interface, a network interface and a memory.

The memory may include a volatile memory, a random access memory (RAM) and/or a non-volatile memory and other forms in a computer-readable medium, such as a read-only memory (ROM) or a flash random access memory (flash RAM). The memory is an example of the computer-readable medium.

The computer-readable medium includes non-volatile and volatile, and removable and non-removable media, which may implement information storage by means of any method or technology. The information may be computer-readable instructions, data structures, program modules, or other data. Examples of the storage medium of a computer include, but are not limited to, a phase change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc-read-only memory (CD-ROM), a digital versatile disc (DVD) or other optical memories, a magnetic cassette, a magnetic tape disk memory or other magnetic storage devices or any other non-transmission media, which may be used for storing information that may be accessed by the computing device. According to the definition herein, the computer-readable medium does not include transitory media, such as modulated data signals and carriers.

It should also be noted that, the terms “include”, “contain” or any other variants thereof are intended to cover non-exclusive inclusions, so that a process, a method, a commodity or a device including a series of elements not only includes those elements, but also includes other elements that are not explicitly listed, or also includes elements inherent to such a process, method, commodity or device. If there are no more restrictions, the element defined by the sentence “including a . . . ” does not exclude the existence of other identical elements in the process, the method, the commodity or the device that includes the element.

In order to better support the present solution, the following specific embodiments are used for description.

The present embodiment provides a specific method for determining the escape of a sweeping robot, including the following steps.

Step S1: establishing a two-dimensional rectangular coordinate system for positions in a room.

According to a cleaning map of the robot, a detection radar of the robot, the mapping of a cleaning region and the size of the cleaning region, accurate size division and position determination may be performed, for example, a wall corner or any other fixed position in the room may be selected as the origin of the rectangular coordinate system, so that position coordinates of obstacles in the cleaning region can be confirmed.

Step S2: the robot enters a sweeping region.

Step S21: recording a walking path (i.e., a historical running trajectory) before entering a narrow region.

During the actual sweeping process of the robot (a sweeping trajectory thereof may be displayed on an actual map and may also be recorded), as shown in FIG. 2, the walking trajectory of the robot before entering the narrow region is a curve S.

Step S22: searching for a driving-in position and a driving-in angle of the corresponding narrow region.

S221: determining the driving-in position.

As shown in FIG. 2, when the robot enters the narrow region, it is assumed that a narrow passage is formed between an obstacle point A and an obstacle point B, and the curve S is an entry path. An intersection between a straight line AB and the curve S is O, and according to the rectangular coordinate system in the room in the step S1, a coordinate point of O at this time is determined as (Oₓ, O_{y}).

S222: determining the driving-in angle of the robot.

As shown in FIG. 2, according to the driving-in position O determined in the step S221, two points near O are selected according to an approximate slope method, for example, coordinates O₂(O₂ₓ, O_{2y}) at a previous second of the intersection O are generated, coordinates O₁(O₁ₓ, O_{1y}) at a subsequent second of the intersection are generated, at this time, the slope of a straight line O₁O₂ is calculated according to a slope calculation formula as:

$${K}_{{O}_{1} {O}_{2}} = \frac{( {O}_{2 y} - {O}_{1 y} )}{( {O}_{2 x} - {O}_{1 x} )} ;$$

and similarly, according to the coordinates of the two obstacle points A and B, the slope K_{AB} of the straight line AB is calculated, at this time, the slope of the vertical line of the straight line AB is:

$$- \frac{1}{{K}_{A B}} ,$$

then an included angle between the straight line O₁O₂ and the vertical line of the straight line AB is:

$$tan α = \frac{( {K}_{{O}_{1} {O}_{2}} + \frac{1}{{K}_{AB}} )}{( 1 - \frac{{K}_{{O}_{1} {O}_{2}}}{{K}_{AB}} )} .$$

Step S3: the robot determines an escape strategy after entering the narrow region.

Step S31: setting an escape mode.

The robot enters a certain region, the sweeping robot cannot leave the region within a period of time t, at this time, the robot sets the escape mode, attempts to leave the region instead of directly giving an alarm.

Step S32: the robot starts to escape.

Step S321: determining a driving-out position and a driving-out angle.

As shown in FIG. 2, when the robot enters the narrow region, the intersection for entry is O, since the entry and exit from the narrow region are in different directions, symmetrical coordinate transformation is performed based on the coordinates of O to find an intersection O′, the logical relationship thereof is a relationship that the coordinates of O′ meet is O′ A=OB (the coordinates of O′ may be easily calculated based on the coordinates of the points A and B and the coordinates of O). The driving-out angle is kept consistent with the driving-in angle and is thus is also a.

Step S322: the robot formally attempts to escape.

Step S3221: as shown in FIG. 2, with O′ as a reference point, the robot is kept to start escaping at an angle α with the vertical line L2 of the straight line AB, and if the robot may directly get out, the robot directly succeeds in escaping.

Step S3222: if the robot cannot directly get out, with the O′ as a reference point, the robot is kept to start preforming a small displacement on the two ends of O′ at the angle α with the vertical line L2 of the straight line AB, wherein the displacement logic thereof is: it is assumed that the robot firstly collides with one side of the obstacle point A when coming out, the displacement direction of the robot is a direction facing the obstacle point B, that is, the robot moves towards the obstacle point B, the distance of keeping the robot to move towards the obstacle point B at the angle α with the vertical line L2 of the straight line AB may be based on the width le (the diameter of a circular robot) of the robot and the length I of the line segment AB, for example, the size of each displacement is

$$s = \frac{( le - l )}{n} ,$$

and the greater the value of n is, the greater the number of times of movement is. The logic of a stop-moving reference is that as long as the robot does not collide with the obstacle point B in the movement direction while attempting to come out (i.e., the obstacle point in the movement direction), if the robot collides with the obstacle point B, the algorithm automatically increases the value of n, and the step S3222 is repeated again until the robot can escape from the narrow region.

Step S4: the robot escapes, marks a complex region, and determines a cleaning strategy.

By means of the above steps, the robot escapes from the narrow region and marks the location as a complex region, the robot may perform a plurality of collision attempts when entering this region next time, and if this region is still consistent with a map during the marking, the robot no longer enters the region for cleaning; and when the region is still consistent with the map during marking, the robot normally cleans the region.

From the above description, it can be seen that the above embodiments of the present disclosure achieve the following technical effects:

1) According to the robot escape method in the present disclosure, the historical running trajectory of the robot is acquired, the driving-in position and the driving-in angle of the robot entering the narrow region through the preset narrow passage are obtained according to the historical running trajectory of the robot, then the driving-out position and the driving-out angle of the robot driving out of the narrow region through the preset narrow passage are determined according to the driving-in position and the driving-in angle, and finally the robot is controlled to drive out of the narrow region based on the driving-out position and the driving-out angle. In the present solution, the driving-out position and the driving-out angle are determined according to the driving-in position and the driving-in angle, so that the robot smoothly drives out of the narrow region, thereby solving the problem of the robot being unable to escape from the narrow region, and improving the user experience.

(2) According to the robot escape apparatus in the present disclosure, the first acquisition unit acquires the historical running trajectory of the robot, the second acquisition unit obtains the driving-in position and the driving-in angle of the robot entering the narrow region through the preset narrow passage according to the historical running trajectory of the robot, the determination unit determines the driving-out position and the driving-out angle of the robot driving out of the narrow region through the preset narrow passage according to the driving-in position and the driving-in angle, and the control unit controls the robot to drive out of the narrow region based on the driving-out position and the driving-out angle. In the present solution, the driving-out position and the driving-out angle are determined according to the driving-in position and the driving-in angle, so that the robot smoothly drives out of the narrow region, thereby solving the problem of the robot being unable to escape from the narrow region, and improving the user experience.

The foregoing descriptions are merely preferred embodiments of the present disclosure and are not intended to limit the present disclosure, and for those skilled in the art, the present disclosure may have various changes and modifications. Any modifications, equivalent replacements, or improvements and the like, made within the spirit and principles of the present disclosure, shall fall within the protection scope of the present disclosure.

1. A robot escape method, comprising:
acquiring a historical running trajectory of a robot;
according to the historical running trajectory of the robot, obtaining a driving-in position and a driving-in angle of the robot entering a narrow region through a preset narrow passage;
according to the driving-in position and the driving-in angle, determining a driving-out position and a driving-out angle of the robot driving out of the narrow region through the preset narrow passage; and
controlling the robot to drive out of the narrow region based on the driving-out position and the driving-out angle.

2. The method according to claim 1, wherein:
the narrow region is formed by a plurality of obstacle points in a surrounding manner, and a narrow passage is formed between two adjacent obstacle points among the plurality of obstacle points, the preset narrow passage is one of the narrow passages;
the driving-in position is an intersection position between a connecting line of the two obstacle points in the preset narrow passage and the historical running trajectory, the driving-in angle is an included angle between an entry direction of the robot and a vertical line, and the vertical line is a straight line perpendicular to the connecting line of the two obstacle points in the preset narrow passage; and
the driving-out position is an intersection position between a trajectory of the robot driving out of the narrow region and the connecting line of the two obstacle points in the preset narrow passage, and the driving-out angle is an included angle between a driving-out direction of the robot and the vertical line.

3. The method according to claim 1, wherein according to the driving-in position and the driving-in angle, determining the driving-out position and the driving-out angle of the robot driving out of the narrow region through the preset narrow passage comprises:
determining a driving-out reference position and a driving-out reference angle;
determining an optimal driving-out position in the neighborhood of the driving-out reference position, and determining an optimal driving-out angle in the neighborhood of the driving-out reference angle; and
determining the optimal driving-out position as the driving-out position of the robot driving out of the narrow region through the preset narrow passage, and determining the optimal driving-out angle as the driving-out angle of the robot driving out of the narrow region through the preset narrow passage.

4. The method according to claim 3, wherein determining the driving-out reference position and the driving-out reference angle comprises:
determining that the driving-out reference angle is equal to the driving-in angle; and
determining the driving-out reference position according to a distance information, wherein the distance information comprises a first distance and a second distance, the first distance is a distance between the driving-in position and a first obstacle point, the second distance is a distance between the driving-out reference position and a second obstacle point, the first obstacle point is an obstacle point corresponding to a smaller distance in distances between the driving-in position and the two obstacle points in the preset narrow passage, the second obstacle point is an obstacle point corresponding to a greater distance in the distances between the driving-in position and the two obstacle points in the preset narrow passage, and the driving-out reference position is selected as a position when the second distance is equal to the first distance.

5. The method according to claim 3, wherein determining the optimal driving-out position in the neighborhood of the driving-out reference position, and determining the optimal driving-out angle in the neighborhood of the driving-out reference angle comprises:
in a case that the robot successfully drives out of the narrow region based on the driving-out reference position and the driving-out reference angle, determining that the driving-out reference position is the optimal driving-out position, and determining that the driving-out reference angle is the optimal driving-out angle;
in a case that the robot does not successfully drive out of the narrow region based on the driving-out reference position and the driving-out reference angle, executing a predetermined step at least once until the robot successfully drives out of the narrow region, wherein the predetermined step comprises: selecting a position in the neighborhood of the driving-out reference position as a current driving-out position, and selecting an angle in the neighborhood of the driving-out reference angle as a current driving-out angle; and
taking the driving-out position selected when the predetermined step is executed for a last time as the optimal driving-out position, and taking the driving-out angle selected when the predetermined step is executed for the last time as the optimal driving-out angle.

6. The method according to claim 1, wherein according to the driving-in position and the driving-in angle, determining the driving-out position and the driving-out angle of the robot driving out of the narrow region through the preset narrow passage comprises:
acquiring a trapped duration of the robot; and
in a case that the trapped duration is greater than a predetermined duration, according to the driving-in position and the driving-in angle, determining the driving-out position and the driving-out angle of the robot driving out of the narrow region through the preset narrow passage.

7. The method according to claim 1, wherein according to the historical running trajectory of the robot, obtaining the driving-in angle of the robot entering the narrow region through the preset narrow passage comprises:
selecting a first point and a second point in the neighborhood of the driving-in position on the historical running trajectory;
acquiring a first slope of a connecting line of the first point and the second point;
acquiring a second slope of the connecting line of the two obstacle points in the preset narrow passage;
determining a third slope of a vertical line according to the second slope, the vertical line is a straight line perpendicular to the connecting line of the two obstacle points in the preset narrow passage; and
determining the driving-in angle according to the first slope and the third slope.

8. The method according to claim 7, wherein the first point and the second point are located on a same side of the historical running trajectory, or the first point and the second point are located on two sides of the historical running trajectory.

9. A robot escape apparatus, comprising:
a first acquisition unit, configured to acquire a historical running trajectory of a robot;
a second acquisition unit, configured to: according to the historical running trajectory of the robot, obtain a driving-in position and a driving-in angle of the robot entering a narrow region through a preset narrow passage;
a determination unit, configured to: according to the driving-in position and the driving-in angle, determine a driving-out position and a driving-out angle of the robot driving out of the narrow region through the preset narrow passage; and
a control unit, configured to: control the robot to drive out of the narrow region based on the driving-out position and the driving-out angle.

10. The robot escape apparatus according to claim 9, wherein:
the narrow region is formed by a plurality of obstacle points in a surrounding manner, and a narrow passage is formed between two adjacent obstacle points among the plurality of obstacle points, the preset narrow passage is one of the narrow passages;
the driving-in position is an intersection position between a connecting line of the two obstacle points in the preset narrow passage and the historical running trajectory, the driving-in angle is an included angle between an entry direction of the robot and a vertical line, and the vertical line is a straight line perpendicular to the connecting line of the two obstacle points in the preset narrow passage; and
the driving-out position is an intersection position between a trajectory of the robot driving out of the narrow region and the connecting line of the two obstacle points in the preset narrow passage, and the driving-out angle is an included angle between a driving-out direction of the robot and the vertical line.

11. (canceled)

12. A robot, comprising: one or more processors, a memory, and one or more programs, wherein the one or more programs are stored in the memory, and when the one or more programs are executed by the one or more processors, the one or more processors are caused to execute the steps of the method according to claim 1.

13. The robot according to claim 12, wherein the robot is a sweeping robot.

14. The method according to claim 2, wherein according to the driving-in position and the driving-in angle, determining the driving-out position and the driving-out angle of the robot driving out of the narrow region through the preset narrow passage comprises:
determining a driving-out reference position and a driving-out reference angle;
determining an optimal driving-out position in a neighborhood of the driving-out reference position, and determining an optimal driving-out angle in a neighborhood of the driving-out reference angle; and
determining the optimal driving-out position as the driving-out position of the robot driving out of the narrow region through the preset narrow passage, and determining the optimal driving-out angle as the driving-out angle of the robot driving out of the narrow region through the preset narrow passage.

15. The method according to claim 2, wherein according to the driving-in position and the driving-in angle, determining the driving-out position and the driving-out angle of the robot driving out of the narrow region through the preset narrow passage comprises:
acquiring a trapped duration of the robot; and
in a case that the trapped duration is greater than a predetermined duration, according to the driving-in position and the driving-in angle, determining the driving-out position and the driving-out angle of the robot driving out of the narrow region through the preset narrow passage.

16. The method according to claim 2, wherein according to the historical running trajectory of the robot, obtaining the driving-in angle of the robot entering the narrow region through the preset narrow passage comprises:
selecting a first point and a second point in the neighborhood of the driving-in position on the historical running trajectory;
acquiring a first slope of a connecting line of the first point and the second point;
acquiring a second slope of the connecting line of the two obstacle points in the preset narrow passage;
determining a third slope of a vertical line according to the second slope, the vertical line is a straight line perpendicular to the connecting line of the two obstacle points in the preset narrow passage; and
determining the driving-in angle according to the first slope and the third slope.

17. The method according to claim 3, wherein according to the driving-in position and the driving-in angle, determining the driving-out position and the driving-out angle of the robot driving out of the narrow region through the preset narrow passage comprises:
acquiring a trapped duration of the robot; and
in a case that the trapped duration is greater than a predetermined duration, according to the driving-in position and the driving-in angle, determining the driving-out position and the driving-out angle of the robot driving out of the narrow region through the preset narrow passage.

18. The method according to claim 3, wherein according to the historical running trajectory of the robot, obtaining the driving-in angle of the robot entering the narrow region through the preset narrow passage comprises:
selecting a first point and a second point in the neighborhood of the driving-in position on the historical running trajectory;
acquiring a first slope of a connecting line of the first point and the second point;
acquiring a second slope of the connecting line of the two obstacle points in the preset narrow passage;
determining a third slope of a vertical line according to the second slope, the vertical line is a straight line perpendicular to the connecting line of the two obstacle points in the preset narrow passage; and
determining the driving-in angle according to the first slope and the third slope.

19. The method according to claim 4, wherein according to the driving-in position and the driving-in angle, determining the driving-out position and the driving-out angle of the robot driving out of the narrow region through the preset narrow passage comprises:
acquiring a trapped duration of the robot; and
in a case that the trapped duration is greater than a predetermined duration, according to the driving-in position and the driving-in angle, determining the driving-out position and the driving-out angle of the robot driving out of the narrow region through the preset narrow passage.

20. The method according to claim 4, wherein according to the historical running trajectory of the robot, obtaining the driving-in angle of the robot entering the narrow region through the preset narrow passage comprises:
selecting a first point and a second point in the neighborhood of the driving-in position on the historical running trajectory;
acquiring a first slope of a connecting line of the first point and the second point;
acquiring a second slope of the connecting line of the two obstacle points in the preset narrow passage;
determining a third slope of a vertical line according to the second slope, the vertical line is a straight line perpendicular to the connecting line of the two obstacle points in the preset narrow passage; and
determining the driving-in angle according to the first slope and the third slope.

21. The method according to claim 5, wherein according to the driving-in position and the driving-in angle, determining the driving-out position and the driving-out angle of the robot driving out of the narrow region through the preset narrow passage comprises:
acquiring a trapped duration of the robot; and
in a case that the trapped duration is greater than a predetermined duration, according to the driving-in position and the driving-in angle, determining the driving-out position and the driving-out angle of the robot driving out of the narrow region through the preset narrow passage.
